(19) United States
(12) Patent Application Publication
(10) Pub. No.: US 2007/0079383 A1
(43) Pub. Date: Apr. 5, 2007

(54) System and Method for Providing Digital Content on Mobile Devices

(76) Inventor: Kumar C. Gopalakrishnan, Mountain View, CA (US)

Correspondence Address: Kumar C. Gopalakrishnan, P.O. Box 2002, Mountain View, CA, 94042, US

(21) Appl. No.: 11/539,634

(22) Filed: Oct. 7, 2006

Related U.S. Application Data
(63) Continuation-in-part of application No. 11/215,601, filed on Aug. 30, 2005.
(60) Provisional application No. 60/724,821, filed on Oct. 7, 2005.
(60) Provisional application No. 60/606,282, filed on Aug. 31, 2004.

(51) Int. Cl. H04N 7/16; H04L 9/32; G06F 17/30; H04L 9/00; H04K 1/00; G06F 12/14; G06F 7/04; G06K 9/00; G06F 11/30; H03M 1/68

(52) U.S. Cl. 726/26; 713/182; 713/183; 713/186; 713/193; 726/27; 726/28; 726/30

(57) ABSTRACT

A system and methods for providing digital content on mobile devices is described. User interfaces and methods for requesting, presentation, communication and storage of digital content are also described.

### CROSS-REFERENCE TO RELATED APPLICATION

This application claims the benefit of U.S. provisional patent application 60/724,821, filed Oct. 7, 2005, and is a continuation-in-part of U.S. patent application Ser. No. 11/215,601, filed Aug. 30, 2005, which claims the benefit of U.S. provisional patent application 60/606,282, filed Aug. 31, 2004. These applications are incorporated by reference along with all other references cited in this application.

### BACKGROUND OF THE INVENTION

The present invention is related to providing digital content on mobile devices. Specifically, the present invention relates to a system for retrieving, presenting and interacting with digital content on mobile devices.

Providing information on portable computer systems which have restricted resources in terms of input and output capabilities is a challenge. Portable computer systems such as cellular phones and other mobile devices are typically equipped with constrained input mechanisms such as a numeric keypad and a joystick or equivalent input components. Similarly, output components integrated into a mobile device such as the display have restricted dimensions and features. Accessing and interacting with digital content through these constrained input and output components, is cumbersome. The present invention addresses this issue by providing a means of accessing digital content and interacting with them.

### BRIEF SUMMARY OF THE INVENTION

The present invention presents a mechanism for accessing and using digital content from a mobile device. Elements of the system are described including a graphical user interface, presentation of digital content and the use of physical components integrated into the mobile device to interact with the digital content. The system enables a user to request relevant digital content by entering textual input on a mobile device. Further, the user may interact with, store and communicate the retrieved digital content.

Other objects, features, and advantages of the present invention will become apparent upon consideration of the following detailed description and the accompanying drawings, in which, like reference designations represent like features throughout the figures.

### BRIEF DESCRIPTION OF THE DRAWINGS

FIG. 1(a) illustrates an exemplary system for providing digital content on a mobile device, in accordance with an embodiment.

FIG. 1(b) illustrates an exemplary view of the components of a mobile device providing digital content, in accordance with an embodiment.

FIG. 2(a) illustrates an exemplary view of the user interface for logging into a system providing digital content, in accordance with an embodiment.

FIG. 2(b) illustrates an exemplary view of the user interface for using menu options, in accordance with an embodiment.

FIG. 2(c) illustrates an exemplary view of the user interface for inputting a query, in accordance with an embodiment.

FIG. 2(d) illustrates an alternate exemplary view of the user interface for inputting a query, in accordance with an embodiment.

FIG. 2(e) illustrates an exemplary view of the user interface for presenting transient digital content, in accordance with an embodiment.

FIG. 2(f) illustrates an exemplary index view of the user interface, in accordance with an embodiment.

FIG. 2(g) illustrates an alternate exemplary index view of the user interface, in accordance with an embodiment.

FIG. 2(h) illustrates an alternate exemplary index view of the user interface, in accordance with an embodiment.

FIG. 2(i) illustrates an alternate exemplary index view of the user interface, in accordance with an embodiment.

FIG. 2(j) illustrates an exemplary content view of the user interface, in accordance with an embodiment.

FIG. 2(k) illustrates an alternate exemplary content view of the user interface, in accordance with an embodiment.

FIG. 3(a) illustrates an exemplary process for requesting and presenting digital content, in accordance with an embodiment.

FIG. 3(b) illustrates an alternate exemplary process for requesting and presenting digital content, in accordance with an embodiment.

FIG. 4 illustrates an exemplary view of an email message communicating digital content, in accordance with an embodiment.

FIG. 5 is a block diagram illustrating an exemplary computer system suitable for use as a system server for providing digital content, in accordance with an embodiment.

### DETAILED DESCRIPTION OF THE INVENTION

A system and methods are described for providing digital content on a mobile device. Various embodiments present mechanisms for requesting, presenting and interacting with digital content on a mobile device. The specific embodiments described in this description represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” or “some embodiments” means that a particular feature, structure, or characteristic described in connection with the embodiment is included in at least one embodiment of the invention. The appearances of the phrase “in one embodiment” or “some embodiments” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

Various embodiments may be implemented in a computer system as software, hardware, firmware or a combination of these. Also, an embodiment may be implemented either in a single monolithic computer system or over a distributed system of computers interconnected by a communication network. While the description below presents the full functionality of the invention, the mechanisms presented in the invention are configurable to the capabilities of the computer system on which it is implemented, the resources available in the computer system on which it is implemented and the requirements for the intended use of the digital content. Various embodiments may also be integrated with other processes and computer systems such that the digital content is used by the processes and computer systems.

In the context of this description, the term “system” is used to refer to a system for providing digital content on mobile devices. The term “digital content” is used to refer to digital information resources that may include resources on the internet, intranet of an organization and other private or public networks and databases. Digital content may contain information in one or more media types such as text, audio, image, graphical and video formats. Examples of digital content include a World Wide Web page, a digital song, a video sequence, a software application, a computer game, an image, a ring tone, an e-commerce transaction, a segment of HTML text, or a segment of plain text. Digital content may be retrieved from several sources including databases and resources internal and external to the system. The databases and resources may be searched or queried using several tools such as web search, product search, and the like.

In the context of this description, the term “user interface element” refers to icons, text boxes, menus, graphical buttons, check boxes, sounds, animations, lists, and the like that constitute a user interface. The terms “widget” and “control” are also used to refer to user interface elements. In the context of this description, the term “input component” refers to a component integrated into the system such as a key, button, joystick, touch pad, motion sensing device, speech input, and the like that can be used to input information to the user interface. In the context of this description, the term “cursor control component” refers to a component integrated into the system such as a key, button, joystick, touch pad, motion sensing device, speech input, and the like that can be used to control a cursor on the user interface. In the context of this description, the term “navigational component” refers to a component integrated into the system such as a key, button, joystick, touch pad, motion sensing device, speech input, and the like that can be used to select, control, and switch between various user interface elements. In the context of this description, the term “menu command” refers to a command associated a menu item on the user interface.

System Architecture

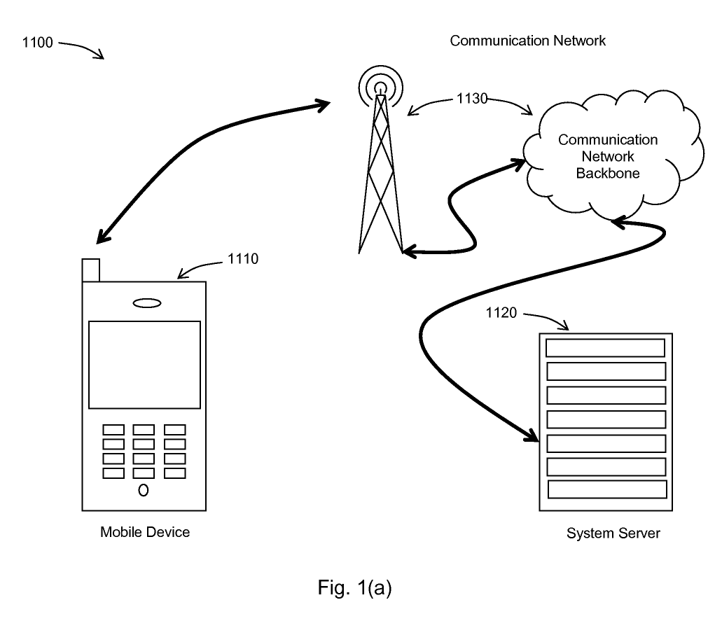

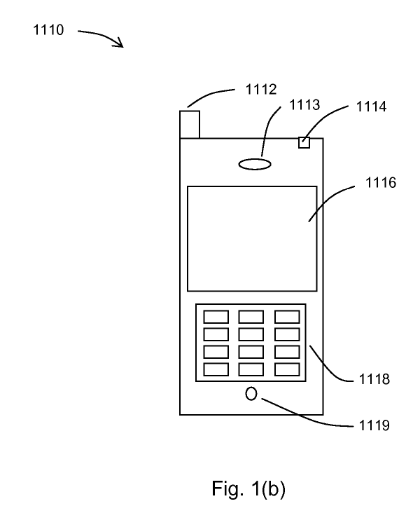

FIG. 1(a) illustrates an exemplary embodiment of a system 1100 for providing digital content on a mobile device that is implemented using a mobile device 1110 and optionally a server computer 1120 that is connected to the mobile device by a communication network constituted of a combination of wired and wireless networks 1130.

Examples of mobile device 1110 include a portable computer system and a cellular phone. Server computer 1120 termed hereafter as the “system server” may implement certain functionalities required to provide digital content on a mobile device. The system server may itself be comprised of a network of computers as in a server farm. The communication network 1130 may be comprised of several elements of wired and wireless networks. Examples of network technologies used in the communication network 1130 include GPRS, UMTS, 1x, EVDO, 802.x, 802.11x, Bluetooth, Ethernet and others. Communication over network 1130 may employ protocols such as UDP, TCP or HTTP.

The distribution of the functionality between a server computer and a mobile device may vary in different embodiments. In some embodiments, the entire functionality of the system may be implemented on the mobile device itself without the need for a server computer.

FIG. 1(b) illustrates the physical components of an exemplary mobile device 1110. Here, the mobile device is a mobile phone that includes a communication antenna 1112, speaker 1113, visual indicator (e.g., LED) 1114, display 1116, keypad 1118 and microphone 11 19.

In some embodiments, the mobile device may also include other input components such as a joystick, thumbwheel, scroll wheel, touch sensitive panel, touch sensitive display, additional keys, etc. In some embodiments, the mobile device may also accept input through audio commands captured through microphone 1119. Audio commands may be interpreted through speech recognition and voice recognition mechanisms.

The mobile device may include a “client” that is comprised of the logic and user interface required to realize the functions of retrieving, presenting, and interacting with digital content. The client may be implemented as a software application using software platforms and operating systems such as J2ME, Series 60™, Symbian™, Windows mobile™, BREW™ and others. In some embodiments, a client may interface with other software components on a mobile device such as Web browser or address book to realize some of its functionality.

A system server may incorporate databases to store user information, digital content, and other system information. Further, the system server may include an application server component to process the messages coming from a mobile device. The application server component implements logic to perform various functionalities of the digital content retrieval process including searching various resources and databases internal and external to the system for digital content, authenticating a user, storing digital content and reformatting digital content as required. The system server may include a communication component to receive messages from a mobile device and to send responses to a mobile device. The communication component may provide communication services such as email, SMS, MMS and instant messaging.

Exemplary User Interface Architecture

The user interface for accessing, presenting, and interacting with digital content on the mobile device 1110 may be comprised of both visual and audio components. Visual components of the user interface may be presented on display 1116 and the audio components on speaker 1113. User inputs may be acquired by the system through keypad 1118, microphone 1119, and other input components integrated into mobile device 1110. In some embodiments, the user interface may be presented using a plurality of devices that together provide the functionality of mobile device 1110. For instance, visual components of the user interface may be presented on a television set while user inputs are obtained from a television remote control.

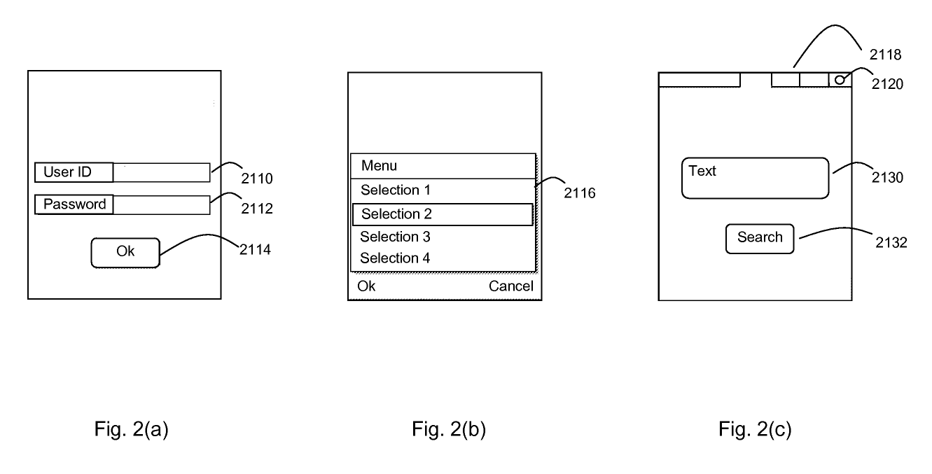

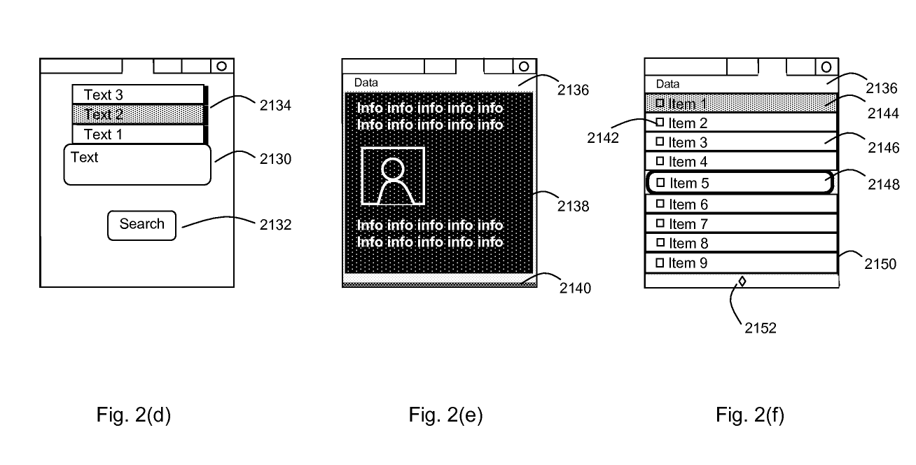

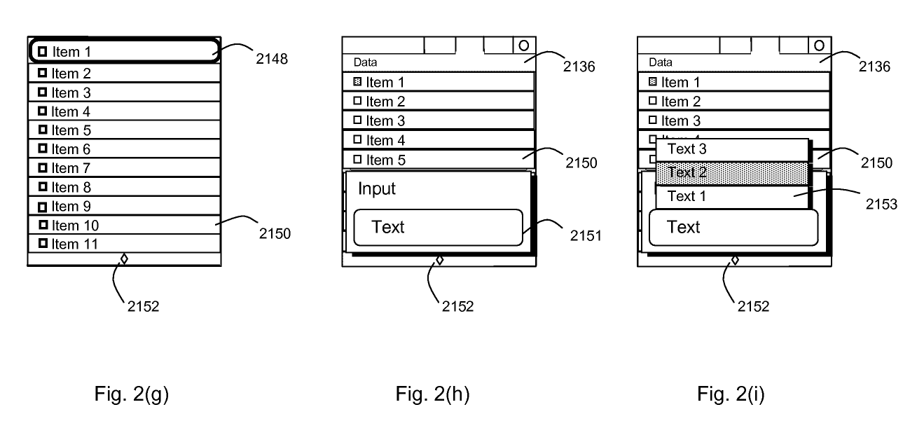

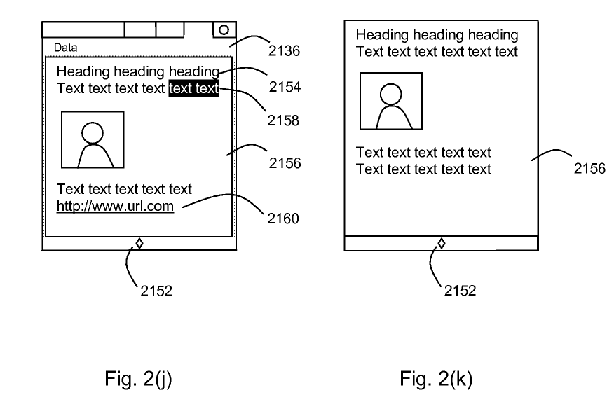

The visual component of the user interface may include a plurality of visual representations herein termed as “views” as illustrated by FIG. 2(a)-2(k). Each view may be configured to address the needs of a specific set of functions of the system as further described.

A “login view” may enable authentication to the system. An “input view” may enable user inputs. Digital content may be presented in “index” and “content” views. An index view may be used to present one or more digital content. A user may browse through the available set of digital content options presented in an index view and select one or more digital content to be presented in a content view or using components external to the system (e.g., a web browser). The digital content presented in the index view may have a compact representation to optimize the use of the display area. The content view may be used to present a digital content in its entirety.

Help information related to the system may be presented in a “help view.” In addition, transient digital content may be presented in a “transient content view.” The user may also interact with the views using various control widgets embedded in the digital content, controls such as menu commands integrated into the user interface and appropriate input components integrated into mobile device 1110.

The views described here may include controls for controlling the presentation of information in audio or video format. The controls may enable features such as play, pause, stop, forward, and reverse of the audio or video information. Audio information may be presented through speaker 1113 or other audio output component connected to the system.

In some embodiments, the user interface may be integrated in its entirety into the system. For example, the user interface may be implemented by a software application (e.g., in environments like J2ME, Symbian, and the like) that is part of the system. In other embodiments, some components of the user interface may be implemented by components external to the system. For example, the index and content views may be integrated into a World Wide Web browser.

In some embodiments, the user interface views may also incorporate elements for presenting various system statuses. If the system is busy processing or communicating information, the busy status may be indicated by a graphical representation of a flashing light 2120. In other embodiments, the busy status may be represented differently. For example, the progress of a system activity over an extended duration of time may be indicated using progress bar 2140. A fraction of progress bar 2140, proportionate to the fraction of the extended duration activity completed, may change color to indicate the progress of the operation. Information may also be presented in auxiliary 2136 or status panes in textual and graphical form.

Further, in some embodiments, the user may be aided in navigating between the different views through use of user interface elements. For example, the different views may be represented in the form of a tabbed panel 2118, wherein various tabs represent different views in the user interface. In some embodiments, the views may be presented as windows that may overlap to various extents. When the information presented by a user interface view extend beyond the physical dimensions of display 1116, scroll indicators 2152 may be used as a guide to scroll through the information presented from the view.

FIG. 2(a) illustrates an exemplary view of the user interface for authenticating users to the system referred to herein as the “login view”. Here, a user can type in an alphanumeric user identifier 2110 and password 2112 into text boxes using a text input device (e.g., keypad 1118) integrated into mobile device 1110. In some embodiments, the user may then initiate the authentication process by highlighting a graphical button 2114 on the user interface and clicking on a joystick or other similar input component on mobile device 1110. In some embodiments, other inputs such as user's speech, user's voice, user's biometric identify (e.g., visual imagery of user's face, fingerprint or palm) or other unique identifiers may be used for authenticating the user. In such embodiments, the login view includes appropriate controls for capturing the authentication information. In some embodiments, the login view may not be present.

FIG. 2(b) illustrates an exemplary menu widget used in the user interface as used in some embodiments. Any of the views described may include appropriate menus for the triggering various commands and functionality of the system. The menu may be navigated using a joystick or other appropriate menu navigation input component integrated into mobile device 1110.

FIG. 2(c) illustrates an exemplary view of the user interface for capturing user inputs referred herein as the “input view” as used in some embodiments. Here, a user may input a query into text input box 2130 using keypad 1118 for retrieving related digital content. The input query may be activated by clicking on the search button 2132. In some embodiments, the input view may include other user interface elements for capturing queries in other non-textual formats such as audio or visual formats.

FIG. 2(d) illustrates an exemplary input view of the user interface where the user is presented suggestions for the text being typed into the text input box 2130. The suggestions may be generated by maintaining a history of the user's past inputs or by using a dictionary of words in a language. The suggestions may be presented on the user interface as a menu 2134 from which the user can select a suggestion using cursor keys integrated into the mobile device 1110.

FIG. 2(e) illustrates an exemplary view of the user interface for presenting transient digital content herein referred to as “transient view”, as used in some embodiments. Here, the transient content in textual, graphical, video or other multimedia format is presented on the transient content pane 2138.

FIG. 2(e) also illustrates progress bar 2140 which may be used to depict the progress of any extended activity in the system as described earlier. FIG. 2(e) also illustrates auxiliary pane 2136 which presents information related to various system parameters, other widgets in the user interface and information derived from digital content presented in the views. In some embodiments, the auxiliary pane may present a preview of information in a digital content. Auxiliary pane 2136 may be used with any of the views in the user interface. In some embodiments, auxiliary pane 2136 may be located in positions other than as illustrated in FIG. 2(e). In some embodiments, auxiliary pane 2136 may be overlaid on top of other user interface widgets. In FIG. 2(e), auxiliary pane 2136 presents a status message “Data.”

In some embodiments, the user interface may employ a lighter color (e.g., white) for presenting information against a dark color (e.g., black) background. Such a color scheme is especially useful while presenting digital content on a backlit LCD display. FIG. 2(e) illustrates such a representation of transient information. Such color schemes may also be used for other views used in the user interface.

FIG. 2(f) illustrates an exemplary view of the user interface for presenting a set of digital content herein referred to as the “index view”, as used in some embodiments. Here, the set of digital content may be presented as list 2150 wherein each item in the list has an icon 2142 and textual information 2146. Icon 2142 may be used to represent various metadata associated with each item in the list (e.g., source of digital content, category of digital content, media type used in digital content, etc.). Icon 2142 may also provide a thumbnail view of visual content included in the digital content.

In the embodiment illustrated in FIG. 2(f), each item in list 2150 has a single icon associated with it. In other embodiments, information associated with each item may be represented by additional graphical information (e.g., icons), additional textual information, special emphasis on textual information (e.g., bold text), audio signals (i.e., sounds) or video or animated visual icons.

Examples of information that may be associated with items in the list include the commercial or sponsored nature of digital content, the fee for accessing commercial digital content, the access rights for the digital content, source of the digital content, the spatial, temporal and geographical location of digital content, the spatial, temporal and geographical availability of digital content, the nature of the digital content in terms of the multimedia types such as audio or video used in the digital content and the nature of the digital content in terms of the adult or mature content used in the digital content are represented.

In some embodiments, the digital content may be presented in a compact form to maximize use of the display space for presenting the digital content. Compact representation of a digital content may involve the use of a subset of the information available in a digital content. For example, a compact representation may show only the title text of a digital content. Audio information may be presented through speaker 1113 integrated into mobile device 1110.

In some embodiments, items in the list may be selected using cursor 2148. In addition, in some embodiments, the items that were previously selected may be depicted with a representation that differs from items that have not been selected. For example, in FIG. 2(f), previously selected item 2144 is shown with a different (i.e., gray) background color while unselected items 2146 are shown with the default (i.e., white) background color.

Information related to the items in the list may also be presented in auxiliary pane 2136 described earlier. For example, price of a book, URL of a web site, WWW domain name, source of a news item, type of a product, time and location associated with a digital content, etc. may be presented in auxiliary pane 2136. In addition, as a user moves cursor 2148, auxiliary pane 2136 may be updated to display metadata related to the item currently highlighted by cursor 2148. In some embodiments, a short clip of the audio information associated with a digital content may be played as preview when an item in the list is selected.

In some embodiments, the index view may also include controls for controlling presentation when presenting information in audio or video format. The controls may enable features such as play, pause, stop, forward and reverse of the audio or video information. Audio information may be presented through speaker 1113 integrated into mobile device 1110. In some embodiments, information that share common attributes (e.g., information sourced from World Wide Web) may be represented using shared attributes such as a common icon, text color or background color.

In some embodiments, the index view may employ a lighter color (e.g., white) for presenting information against a dark color (e.g., black) background. Such a color scheme is especially useful while presenting digital content on a backlit LCD display.

FIG. 2(g) illustrates an exemplary view of the user interface for presenting a set of herein referred to as the “index view” as used in some embodiments. Here, the index view integrates fewer controls compared to the view illustrated in FIG. 2(f) to maximize the use of the display area for presenting the list of digital content. In some embodiments, the list may occupy the entire display area. Other functionality of this alternate representation of the index view are similar to the index view illustrated in FIG. 2(f).

FIG. 2(h) illustrates an alternate index view of the user interface for presenting a set of digital content. Here, a text input box 2151 is superimposed on the list of digital content 2150. This text input box may be used to input new queries or to refine previously defined queries. Further, to aid the refining of previously defined queries, the queries may be automatically displayed on the text input box such that the user can edit them to define the new query.

FIG. 2(i) illustrates an alternate index view of the user interface for presenting a set of digital content. Here, the text input box 2151 superimposed on the list of digital content 2150 displays suggestions 2153 for the query being input by a user as the user inputs the query. The suggestions may be generated from user's history and dictionaries as described earlier. The user may then use navigation controls integrated into the mobile device 1110 to select from the list of suggestions.

FIG. 2(j) illustrates an exemplary view of the user interface for presenting digital content herein referred to as the “content view”, as used in some embodiments. Here, the visual component of a digital content is presented in content pane 2156. Digital content presented on content pane 2156 may include information in text, image and video formats. Audio information may be presented through speaker 1113 integrated into mobile device 1110.

In some embodiments, the content view may also include controls for controlling presentation when presenting information in audio or video format. The controls may enable features such as play, pause, stop, forward and reverse of the audio or video information. The digital content presented in content pane 2156 may also include formatting such as a heading 2154. Information associated with the digital content may also be presented in auxiliary pane 2136. The scroll indicators 2152 serve to guide the navigation of the content presented as described earlier.

In some embodiments, parts of the content presented may be identified as significant. For instance, here, text of significance is highlighted 2158. In other embodiments, a region of significance may be depicted through other textual (e.g., bold vs. regular typeset, change in color, underlining, flashing) and graphical marks a (e.g., icons, etc). A graphical cursor may be used in conjunction with cursor control keys, joystick or other similar input components to highlight presented information. Further, hyperlinks such as 2160 may be embedded in the content to request additional information associated with the digital content presented. The additional digital content accessed using the hyperlink may either be presented using the user interface (e.g., index view or content view) or using components external to the system (e.g., a web browser).

In some embodiments, the content view may employ a lighter color (e.g., white) for presenting information against a dark color (e.g., black) background. Such a color scheme is especially useful while presenting digital content on a backlit LCD display.

FIG. 2(k) illustrates an exemplary view of the user interface for presenting digital content herein referred to as the “content view”, as used in some embodiments. Here, the content view integrates fewer controls compared to the view illustrated in FIG. 2(j) to maximize the use of the display area for presenting the digital content. Other functionality of this view is similar to the view illustrated in FIG. 2(j).

The user interface may also allow customization. Such customizations of user interfaces are commonly referred to as themes or skins. User interface options that are thus customized may include color schemes, icons used in the user interface, the layout of the widgets in the user interface and commands assigned to various functions of the user interface. The customization may be either specified explicitly by the user or determined automatically by the system based on criteria such as system and environmental factors.

System factors used by the system for customizing the user interface include the capabilities of mobile device 1110, the capabilities of the communication network, the system learned preferences of the user and the media formats used in the digital content being presented. Another system factor used for the customization may be the availability of sponsors for customization of the user interface. Sponsors may customize the user interface with their branding collateral and advertisement content. Environmental factors used by the system for customizing the user interface may include the geographical and spatial location, the time of day of use and the ambient lighting.

The user interface may enable communication of digital content presented in the views using communication services such as email, SMS, MMS and the like. For instance, the list of digital content presented in the index view or the digital content presented in detail in the content view may be communicated to a recipient as an email using appropriate menu commands or by activating appropriate graphical user interface widgets.

The user interface may also enable storage of digital content presented in the views. For instance, the list of digital content presented in the index view or the digital content presented in detail in the content view may be stored for later access and use, using appropriate menu commands or by activating appropriate graphical user interface widgets.

User Interface Input Mechanisms

In the context of this description, the term “click” refers to an user input on the user interface wherein, the user clicks on a key, button, joystick, scroll wheel, thumb wheel or equivalent integrated into mobile device 1110, the user flicks a joystick integrated into mobile device 1110, the user spins or clicks a scroll wheel, thumb wheel or equivalent, or the user taps on a touch sensitive or pressure sensitive input component. In the context of this description, the term “flick” refers to a movement of a joystick, scroll wheel, or thumb wheel in one of its directions of motion.

In addition, in the context of this description, the term “click” may refer to 1) the transitioning of an input component from its default state to a selected or clicked state (e.g. key press), 2) the transitioning of an input component from its selected or clicked state to its default state (e.g. key release) or 3) the transitioning of an input component from its default state to a selected or clicked state followed by its transitioning back from the selected or clicked state to its default state (e.g. key press followed by a key release). The action to be initiated by the click input may be triggered on any of the three versions of click events defined above as determined by the implementation of a specific embodiment.

In addition, input components may also exhibit a bistate behavior wherein clicking on the input component once transitions it to a clicked state in which it continues to remain. If the input component is clicked again, the input component is returned to its default or unclicked state. This bistate behavior is termed “toggle” in the context of this description.

In the context of this description, the term “click hold” is used to refer to a user input on the user interface that has an extended temporal duration. For example, the user may click on a key or button integrated into the mobile device and hold it in its clicked state or the user may click on a joystick integrated into the mobile device and hold it in its clicked state or the user may flick a joystick integrated into mobile device 1110 and hold it in its flicked state or the user may spin or click a scroll wheel, thumb wheel or equivalent and hold the wheel in its engaged state or the user may input a single input on a touch sensitive or pressure sensitive input component and continue the input in an uninterrupted manner.

The end of the click hold operation, and hence the duration of the click hold event, is marked by the return of the input component to its default or unclicked state. The action to be initiated by the click hold input may be triggered either at the transition of a key from its default state to its clicked state, after the user holds the input component in its clicked state for a previously specified period of time or on return of the input component from its clicked state to its default state.

The difference between a click and a click hold is that a click represents an instantaneous moment, while a click hold represents a duration of time, with the start and end of the duration marked by the click and the release or return of the input component to its unclicked or default state.

In some embodiments, speech input may also be used to generate commands equivalent to clicks, click holds, and toggles using speech and voice recognition components integrated into the system. Further, speech input may also be used for control cursor, highlighting, selection of items in lists and selection of hyperlinks.

Graphical Widgets, Their Selection and Operation

Clicks, click holds, toggles, and equivalent inputs may optionally be associated with visual feedback in the form of widgets integrated into the user interface. An example of a simple widget integrated into the user interface is a graphical button on the mobile device's display 1116. In some embodiments, a plurality of such widgets integrated into the user interface may be used in conjunction with an input component, to provide a plurality of functionalities for the input component. For example, a joystick may be used to move a selection cursor between a number of graphical buttons presented on the mobile device display to select a specific mode of operation. Once a specific mode of operation has been selected, the system may present the user interface for the selected mode of operation which may include redefinition of the actions associated with the activation of the various input components used by the system. Effectively, such a graphical user interface enables the functionality of a plurality of “virtual” user interface elements (e.g. graphical buttons) using a single physical user interface component (e.g., joystick).

Using an input component to interact with multiple widgets in a graphical user interface may involve a two step process: 1) a step of selecting a specific widget on the user interface to interact with and 2) a step of activating the widget.

The first step of selecting a widget is performed by pointing at the widget with an “arrowhead” mouse pointer, a cross hair pointer or by moving widget highlights, borders and the like, upon which the widget may transition from the unselected to selected state. Moving the cursor away from a widget may transition it from the selected to unselected state. The second step of activating the widget is analogous to the click or click hold operations described earlier for physical input components.

In the context of this description, the term “widget select” is used to describe one of the following operations: 1) the transitioning of a widget from unselected to selected state, 2) the transitioning of a widget from selected to unselected state, or 3) the transitioning of a widget from unselected to selected state followed by its transitioning from selected to unselected state. The term “widget activate” is used to refer to one of the following operations: 1) the transitioning of a widget from inactive to active state, 2) the transitioning of a widget from active to inactive state, or 3) the transitioning of a widget from inactive to active state followed by its transitioning from active to inactive state. A “widget hold” event may be generated by the transitioning of a widget from inactive to active state and the holding of the widget in its active state for an extended duration of time. The return of the widget to its default or inactive state may mark the end of the widget hold event.

In addition, widgets may optionally exhibit a bistate behavior wherein clicking on the input component once while a widget is selected transitions it to an activated state in which it continues to remain. If the widget which is now in its activated state is selected and the input component clicked again, the widget is returned to its default or inactive state. This bistate behavior is termed “widget toggle.”

Widget activate, widget hold and widget toggle events may be generated by the user using clicks, click holds, toggles and equivalent inputs generated using an input component integrated into mobile device 1110, in conjunction with widgets selected on the graphical user interface.

The selection of a widget on the user interface may be represented by changes in the visual appearance of a widget, e.g., through use of highlights, color changes, icon changes, animation, drawing of a border around the widget or other equivalent visual feedback, through the use of audio feedback such as sounds or beeps or through tactile feedback such as vibrations. Similarly, the activation of a widget using a widget activate operation or an extended activation of a widget using a widget hold operation may be represented by changes in the visual appearance of a widget, e.g., through use of highlights, color changes, icon changes, animation, drawing of a border around the widget or other equivalent visual feedback, through use of audio feedback such as sounds or beeps or through tactile feedback such as vibrations.

Widget select events may be input using an input component that supports selection between a plurality of widgets such as a mouse, joystick, scroll wheel, thumb wheel, touch pad or cursor control keys. Widget activate, widget toggle and widget hold events may be input using input components such as a mouse, joystick, touch pad, scroll wheel, thumb wheel or hard or soft buttons.

In some embodiments, speech input may also be used to generate commands equivalent to click, click hold, toggle, widget select, widget activate, and widget hold events using speech and voice recognition components integrated into the system.

Equivalency of User Interface Inputs

In some embodiments, clicks may be substituted with a click hold, where the embodiment may interpret the click hold such as to automatically generate a click or toggle event from the click hold user input using various system and environmental parameters.

In some embodiments, a click or toggle may be substituted for a click hold. In this case, the implicit duration of the click hold event represented by a click or toggle may be determined automatically by the system based on various system and environmental parameters as determined by the implementation. Similarly, widget activate, widget toggle, and widget hold operations may also be optionally used interchangeably when used in conjunction with additional system or environmental inputs, as in the case of clicks and click holds.

While the following description describes the operation of embodiments using clicks and click holds, other embodiments may substitute these inputs with toggle, widget select, widget activate, widget toggle, and widget hold operations. For instance, in some embodiments, the selection of a button widget may be interpreted as equivalent to a click. In some embodiments, some user interface inputs may be in the form of spoken commands that are interpreted using speech recognition.

Features of Visual Components of User Interface

In some embodiments that use input components in conjunction with selectable widgets on the user interface, the process of selecting a widget on the user interface and widget activating or widget toggling or widget holding using a input component is intended to provide a look and feel analogous to clicking or toggling or click holding respectively on an input component used without any associated user interface widgets. For instance, selecting a widget in the form of a graphical button by moving a cursor in the form of a border around the button using a joystick and activating the widget by clicking on the joystick is a user experience equivalent to clicking on a specific physical button.

Features of Audio Components of User Interface

In some embodiments, the user interface may employ audio cues to denote various events in the system. For instance, the system may generate audio signals (e.g., audio tones, audio recordings) when the user switches between different views, inputs information in the user interface, uses input components integrated into the mobile device (e.g., click, click hold, toggle), uses widgets integrated into the mobile device user interface (e.g., widget select, widget activate, widget toggle, widget hold) or to provide an audio rendering of system status and features (e.g., system busy status, updating of progress bar, display of menu options, readout of menu options, readout of information options).

In some embodiments, the system may provide an audio rendering of the information in various media types in the digital content generated by the system. This enables users to browse and listen to the digital content without using the visual components of the user interface. This feature in conjunction with the other audio feedback mechanisms presented earlier may enable a user to use all features of the system using only the audio components of the user interface, i.e., without using the visual components of the user interface.

System Operation

The system enables users to enter text, request related digital content and interact with the retrieved digital content on a mobile device. In some embodiments, digital content provided may include information retrieved from various sources such as Web sites, Web search engines, news agencies, e-commerce storefronts, comparison shopping engines, entertainment content, games, and the like. In some embodiments, the digital content provided may modify or add new components (e.g., software applications, games, ring tones, etc.) to the mobile device. Information included in the digital content may be in textual, audio or visual media types. [102] Users may use the different views of the user interface described earlier to perform various functions related to requesting, accessing and using digital content. Interacting with the user interface is through use of appropriate input components integrated into mobile device 1110. [103] When the system is busy performing an operation, the busy status of the system may be indicated on the user interface. For example, the busy indicator 2120 may be flashed when the system is busy performing an operation. Also, when the system is performing an operation of extended duration, the progress of execution of the operation may be indicated by continually updating an appropriate indicator on the user interface. For example, progress bar 2140 may be colored to reflect the progress in execution of an operation of extended duration. Further, when a digital content being presented on the user interface is configured to be presented in a space larger than the space available for presenting a digital content on the user interface, a scroll indicator such as 2152 may be updated to indicate the extent of the digital content being presented.

Requesting Digital Content

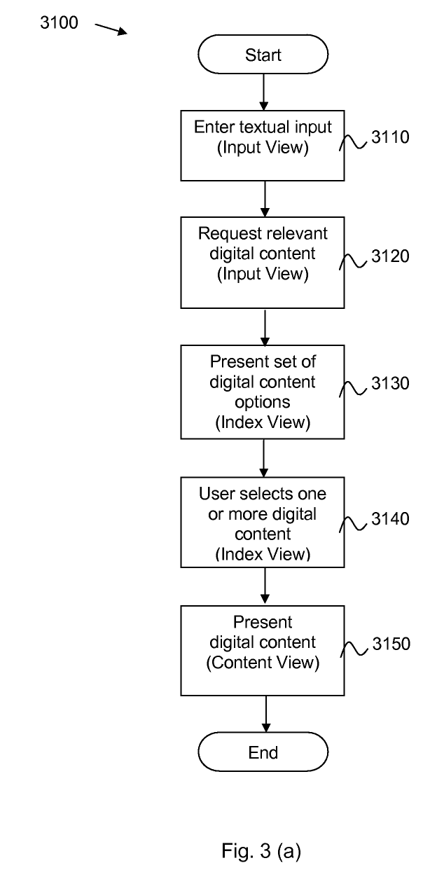

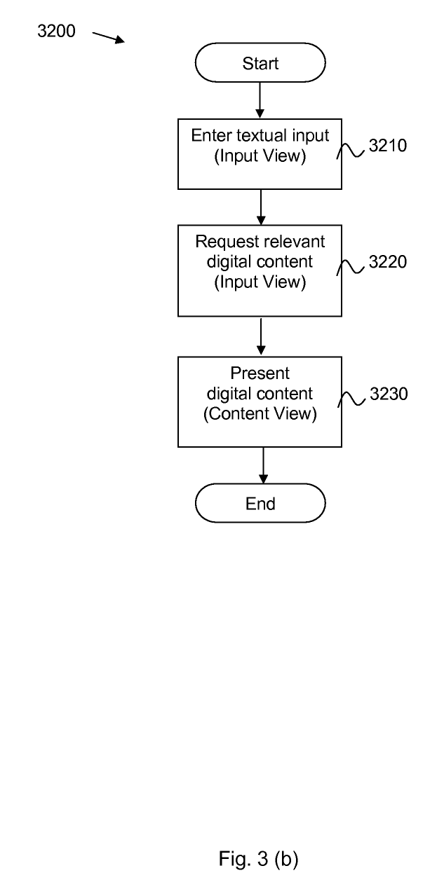

FIG. 3(a) illustrates an exemplary process 3100 for requesting and presenting digital content on a mobile device user interface. Process 3100 and other processes of this description may be implemented as a set of modules, which may be process modules or operations, software modules with associated functions or effects, hardware modules designed to fulfill the process operations, or some combination of the various types of modules. The modules of process 3100 and other processes described herein may be rearranged, such as in a parallel or serial fashion, and may be reordered, combined, or subdivided in various embodiments.

Here, a user enters textual query for related digital content using the input view of the mobile device user interface 3110. In some embodiments, the user may then request related digital content by activating a key or button on the mobile device dedicated to such function 3120. In some embodiments, the request may be initiated by a menu command, a widget select or a widget activate. The request may then be transmitted to the system server. The system server searches and queries various sources and databases internal and external to the system and returns a set of digital content. The set of digital content is then presented as a list in the index view of the user interface 3130.

The user may then select and activate one or more digital content presented in the index view for further presentation in the content view 3140. The selected digital content is then presented in the content view 3150. In some embodiments, transient digital content may be presented in a transient content view before digital content is presented in the index and content views.

FIG. 3(b) illustrates an alternate exemplary process 3200 for requesting and presenting digital content on a mobile device user interface. Here, the user inputs a query for related digital content using the input view of the mobile device user interface 3210. In some embodiments, the user may then request related digital content by activating a key or button on the mobile device dedicated to such function 3220. In some embodiments, the request may be initiated by a menu command, a widget select or a widget activate. The request may then be transmitted to the system server. The system server searches and queries various sources and databases internal and external to the system and returns a digital content evaluated to be most related to the input query. The digital content is then presented in the content view of the user interface 3230.

In some embodiments, the user may have to authenticate to the system before operating the system. Authentication may be performed by the user inputting authenticating credentials such as a user identifier or password to the system using the login view. The authentication may be performed by the user using the login view prior to inputting the query using the input view.

In some embodiments, the authentication credentials may be retrieved from storage on the mobile device 1110 and used for authentication. In some embodiments, authentication may be performed with the device identifier such as IMEI. In some embodiments, authentication information may be transmitted to the system server for authentication. In some embodiments, authentication may be performed on the mobile device itself.

In some embodiments, users may request digital content which may be provided to them over an extended duration of time. For instance, users may request digital content related to a keyword which may be sent to them on a regular basis, such as daily, or on occurrence of events, such as the publication of new digital content related to a keyword in the system.

Content Presentation

Digital content provided through the system is presented in the index and content views of the mobile device user interface. In some embodiments, the digital content may be automatically transformed for appropriate presentation on the user interface. Such transformation includes format conversions such as resizing, restructuring, compression technique changes, summarization, etc. and media type conversions such as the conversion of audio to textual information or video sequences to still images. The system automatically decides on the optimal transformations to perform based on criteria such as user preferences, capabilities of the mobile device, capabilities of the network inter connecting the mobile device and the system server, type of the digital content, nature of the digital content such as sponsored or commercial, source of the digital content, etc.

In some embodiments, some digital content may be sourced from the World Wide Web. These content are identified and obtained by searching the Web for content relevant to the textual input. In some embodiments, when a user requests the system to present the digital content in their entirety in the content view, information in the form of one or more snippets of the content from the identified Web pages may be presented as representative of the content in its original form available on the Web pages. The snippets derived from the Web pages are typically greater than 300 characters in length, if such textual content is available on the Web page.

In some embodiments, the textual content available on Web pages may be summarized or abridged before presentation by the system. In addition, other non-textual content available on the Web pages such as audio, video or images are optionally reformatted and transcoded for optimal presentation on the user interface.

In addition, the information presented optionally includes a headline before the snippets, a partial or complete URL of the Web page and hyperlinks to the actual Web pages. The title may be derived from the title of the associated Web pages or synthesized by the invention by interpreting or summarizing the content available in the Web pages. The title and/or the URL may be optionally hyperlinked to the Web page. The hyperlinks embedded in the information presented enables users to view the Web pages in their original form if necessary. The user may click on the hyperlinks to request the presentation of the Web page in its original form. The Web pages may also be optionally presented in a Web browser or HTML/XHTML viewer integrated into mobile device 1110.

When a digital content is presented in index or content views, parts of the presented content may be hyperlinked. Such hyperlinked parts may be differentiated with the rest of the content using distinct formats such as colors, underlines, text style, etc or using graphical marks such as a bounding rectangle, icons, animations or, flashing. The hyperlinks may be part of the original digital content or synthesized by the system server.

Hyperlinks may be selected and activated. In some embodiments, other software applications or functionality integrated into mobile device 1110 may be triggered or launched upon the user's selection and activation of specific types of hyperlinks in the content. Hyperlinks may be activated by clicking on them.

For instance, when a user clicks on a hyperlink to a Web page using appropriate navigation control components or keys, a Web browser or HTML/XML viewer integrated into mobile device 1110 may be launched. Certain hyperlinks may include a phone number, which may be used to set up a voice call, send a SMS, send a MMS or save the phone number to an address book using appropriate features on mobile device 1110, when a user clicks on the hyperlink.

Other hyperlinks may include an email address which may be used to send an email or save the email address to an address book, using appropriate software components on mobile device 1110. In yet another scenario, a hyperlinked content may include a time which may be used to launch a calendar component integrated into mobile device 1110. In still another example, a hyperlinked content may include an address which may be used to launch a mapping or driving directions component integrated into mobile device 1110.

In still another example, a hyperlink may include a World Wide Web Uniform Resource Locator (URL) which may be used to store the URL as a bookmark. Hyperlinks related to audio or video information may launch the appropriate audio or video playing components upon a user's click. Other hyperlinks may launch specialized commercial transaction software for executing commercial transactions.

In some embodiments, a user may mark certain regions of the digital content presented on the content view as regions of significance. The content view enables this markup through support for a cursor to select the regions in conjunction with cursor control input components (e.g., cursor control keys, joystick, etc.) integrated into mobile device 1110. The marked regions may be visually demarcated using techniques such as change in color, underlining, bounding rectangle and others.

The user may then request digital content relevant to the marked regions using menu commands, keys assigned to this function or using other input components. Upon the request, the system server may identify relevant digital content and return them to the mobile device. The relevant digital content identified may then be displayed in the index or content views.

Transient Digital Content

In some embodiments, transient digital content may be presented on the user interface using a transient content view. Transient digital content may be presented between any two operations on the user interface. Operations include inputs made using an input component on the mobile device, any change in the display of the mobile device such as switching between views, presenting pop-up widgets and others. In some instances, transient digital content may also be presented based on system events such as timer events.

For example, transient digital content may be presented between any two operations illustrated in FIGS. 3(a) through 3(b). In some embodiments, transient digital content may be presented between switching between an input view and an index view or vice versa. In some embodiments, transient digital content may be presented between switching between an index view and a content view or vice versa.

Examples of scenarios when the transient digital content is presented include when the system is busy executing an operation of extended duration, when sponsored digital content are to be presented before presenting non-sponsored digital content and when system messages (notifications for users of the system) are to be presented. Such transient digital content presented in a transient content view may be replaced by other views automatically by the system or upon appropriate input from the user using appropriate components integrated into mobile device 1110.

Transient digital content may or may not be relevant to the textual input. Transient digital content may include digital content in any media type such as audio, video, text or graphics. Transient digital content may be sponsored in nature i.e., the provider of the digital content pays the operator of the invention for presenting the digital content on a mobile device during the use of the system by a user. Sponsored digital content may or may not be relevant to the textual input. Examples of sponsored digital content include advertisements, commercials, infomercials, product or service promotions and others.

In some embodiments, when the user requests digital content relevant to textual input, sponsored digital content is presented in a transient content view before presentation of the relevant digital content. Thus, the user is required to view the sponsored digital content before viewing the requested relevant digital content. In some embodiments, transient digital content may be presented when the user selects a digital content on the index view and activates it to view the item in its entirety in the content view.

Furthermore, in some embodiments, the user may be presented with an option along with the sponsored digital content to skip the presentation of the sponsored digital content before it is presented completely. Such an option may be implemented using specific input components on the mobile device, graphical widgets, menu commands or others.

When transient digital content is presented on the user interface, the transient digital content may also contain hyperlinks similar to the hyperlinks described in the presentation of a digital content in the content view. As in the case of the content view, such hyperlinks when activated may launch specific services using the mobile device user interface or components external to the system such as Web browser on the mobile device.

In some embodiments, activating a hyperlink on the transient digital content may result in the presentation of set of digital content in the index or content views. In some embodiments, activating a hyperlink may lead to executing of an e-commerce transaction. Similarly, the mobile device user interface also enables a user to mark regions of significance in the transient digital content and request digital content relevant to the marked regions. Transient digital content presented in the transient content view may also be communicated as described in the section on the communication of digital content. Transient digital content may also be stored in persistent storage.

Retrieving Similar Digital Content

In some embodiments, the user may be able to select one or more digital content on the index or content view and request additional digital content similar to the selected digital content. In the index view, if multiple digital content are presented the user may be able to select one or more digital content and request the system for similar digital content. In the content view, a user may be able to request for digital content similar to the one presented. Selection of digital content may be performed through a widget select.

The request for similar digital content may be initiated using a menu command, activation of a special key or using other input components on the mobile device. Upon requesting similar digital content, the system may respond with digital content identified as similar to the one selected. The resulting similar digital content may be presented on the index view or on the content view. The system server may measure similarity of a digital content with another digital content based on a number of factors including the source of the digital content, the closeness of the textual information in the digital content, the media types used in the digital content, the category of the digital content, the time of authoring of the digital content, the commercial or sponsored nature of the digital content, and other metadata associated with the digital content.

Communicating Digital Content

In some embodiments, the digital content retrieved on mobile device 1110 relevant to a textual input may also optionally be communicated to recipients using communication services such as email, SMS, MMS and the like. Communication of digital content may be initiated with a click on an input component on the mobile device, a menu command or a widget select or a widget activate. The process of communicating the digital content may include the specification of recipients and mode of communication of the digital content.

Digital content may be communicated from any of the views such as index view, content view, transient content view or others. If multiple digital content are presented in the index view, the user may be able to select one or more digital content for communication. In some embodiments, the user may be able to communicate all the digital content in the index view without selecting them. For example, the index view may optionally include menu commands to email the list of digital content presented on the index view to recipients.

The content view may also include menu commands to email the digital content presented in the content view to recipients. The recipient's email address may be entered on the user interface manually by the user or obtained from an address book component integrated into mobile device 1110. In some embodiments, the recipient email address may be retrieved from the system server. The recipient of the email or other forms of communication may be the user himself.

In some embodiments, communication of digital content may be routed through the system server or directly delivered to a destination address from the mobile device without the intermediation of the system server. In some embodiments, where a communication is routed through the system server, the communication from the mobile device to the system server may or may not be in a standard format.

The communication from the mobile device to the system server may not use a standard protocol used for that type of communication. For instance, the communication from a mobile device to the system server may be in a proprietary format and protocol and the system server may deliver the message using a standard email protocol such as SMTP. When the communication is routed through the system server or sent directly from the mobile device to a destination one or more servers and systems external to the system such as third party SMTP servers, destination SMTP servers, SMS or MMS gateways and instant messaging servers may be involved.

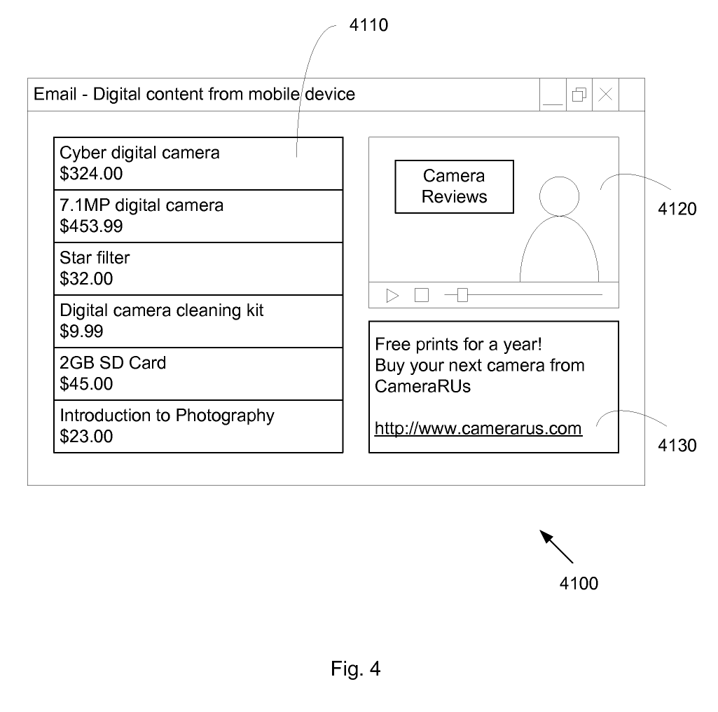

FIG. 4 illustrates an exemplary view 4100 of digital content communicated as an email message. Here, a plurality of digital content communicated from the mobile device is presented as a list 4110.

In some embodiments, when digital content are communicated from mobile device 1110, the system may add additional digital content 4120 to the communicated message. The additional digital content may or may not be relevant to the textual input made on the mobile device. In some embodiments, hyperlinks 4130 to additional digital content may be added by the system to the communicated message.

The additional digital content may be formatted along with the original content in several formats in the communicated message. The additional digital content may include different media types such as audio, video, text and graphics. In some embodiments, the additional digital content may be formatted such that they are indistinguishable from the original digital content. In some embodiments the additional digital content may have different visual representations such that they are easily distinguished from the original digital content.

In some embodiments, additional digital content may be interleaved with the original content in a list. In some embodiments, the additional and original digital content may be presented as two different lists. Also, the additional digital content may be formatted such that they are spatially interspersed in several places in the presentation of the communicated message. Additional digital content may be sponsored in nature i.e., the provider of the digital content pays the operator of the system for providing the digital content to the user.

Storing Digital Content

In some embodiments, the digital content retrieved on the mobile device 1110 as relevant to a textual input may also optionally be stored in storage. Storing of digital content may be initiated by performing appropriate operations on the user interface such as using a menu command, a click, a widget select or a widget activate. Digital content may be stored from an index view, content view or a transient content view. For example, a menu command may be used to store digital content from an index view or a content view. If multiple digital content are presented in the index view, the user may be able to select one or more digital content for storing. In some embodiments, the user may be able to store all the digital content in the index view without selecting them.

The digital content may be stored in a file system component integrated into mobile device 1110 or other in components such as an address book or a calendar. For instance, email addresses and other contact information from digital content may be stored in an address book component while appointments may be stored in a calendar component. In some embodiments, the digital content may be stored in other systems such as a system server or user's personal computer. In some embodiments, the stored digital content may be retrieved and used using the client on the mobile device presented here. In other embodiments, the stored digital content may be retrieved and used using components external to the system such as other tools on the mobile device. In some embodiments, the store digital content may be retrieved and used by other devices such as a computer.

Presenting Help Information

In some embodiments, the user interface may include a mechanism for presenting help information. In some embodiments, the request for help information may be initiated using menu commands. In other embodiments, the request for help information may be initiated using a special key or other input components integrated into mobile device 1110.

User Interface Accelerated Input

In certain embodiments of the invention, after entering the query input, the user may request relevant digital content from a specific source or database or request a specific type of digital content. The user may execute this targeted request by clicking on an input component integrated into the mobile device, where each input component is assigned to a specific source or type of digital content. For instance, the user may click a graphical soft button on the display named WWW to request relevant digital content only from World Wide Web. In some embodiments, the user after entering textual input may click a specific key on the mobile device; say the key marked “2” to request digital content associated with shopping products or services.

In these operations the system searches or queries only the specific databases or sources and presents the user with a list of relevant digital content from them. In some embodiments, a plurality of sources of digital content may be mapped to each input component. In some embodiments, the user may click on a plurality of the input components to simultaneously select a plurality of sources or types of digital content. Further in some embodiments, the functionality described above for keys integrated into the mobile device may be offered by widgets integrated into the user interface. In other embodiments, the functionality of the keys may be implemented using speech inputs.

Predictive Text Input

In some embodiments, the text box used for entering a textual input in the input view, index view or the content view may also have a predictive text capability. When a user enters partial text within the text box, the predictive text capability presents a list of text options that can be selected by the user to complete the text input. This minimizes the number of key presses made by the user since he can select a text from the presented text options with fewer key presses than that used to input text.

Such predictive text is generated by the system based on several factors such as the language dictionary, grammar, and thesaurus, the information previously entered in the text box, usage history of the user, frequency of use of words and others. Predictive text generation also takes into account the factor that three or more alphabets are mapped into each key in a typical mobile device keypad. For example, when a key mapped to “2, a, b, c” is pressed the text generation algorithm uses all the 4 characters to predict potential text completion options. As a user enters every character on the text box different text options may be presented for the user to select from. The user may select a presented option or continue to enter the text. The user may also have an option to enter additional text after selecting an option.

Multiple Facets of System Operation

In some embodiments, the system may feature multiple facets of operation. The facets enable a user to select between subsets of features of the system. For instance, a specific facet may feature only a subset of digital content identified as related to a user query. In other embodiments, a specific facet may feature only a subset of the menu commands available for use. In embodiments supporting multiple facets, users may select one among the available set of facets for access to the features of the selected facet. This enables users to use facets i.e., feature sets, appropriate for various use scenarios.

Users may switch between different facets of operation of the system using appropriate user interface elements. For instance, in some embodiments, users may select a specific facet by using a specific input component (e.g., by clicking on a specific key on the keypad) or by activating a specific widget in the user interface (e.g., by selecting and activating a specific icon in the user interface).

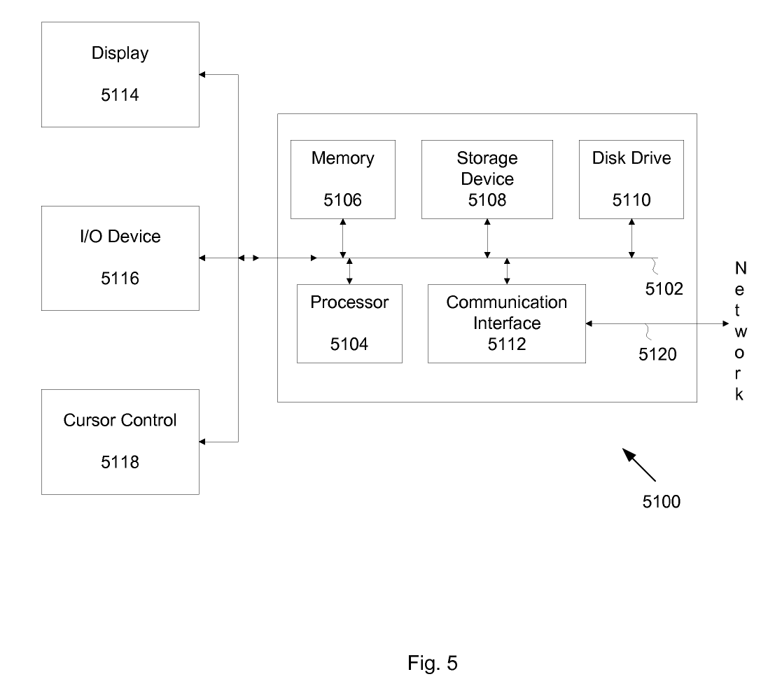

FIG. 5 is a block diagram illustrating an exemplary computer system suitable for use as a system server for providing digital content on mobile devices. In some embodiments, computer system 5100 may be used to implement computer programs, applications, methods, or other software to perform the above described techniques for providing digital content.

Computer system 5100 includes a bus 5102 or other communication mechanism for communicating information, which interconnects subsystems and devices, such as processor 5104, system memory 5106 (e.g., RAM), storage device 5108 (e.g., ROM), disk drive 5110 (e.g., magnetic or optical), communication interface 5112 (e.g., modem or Ethernet card), display 5114 (e.g., CRT or LCD), input device 5116 (e.g., keyboard), and cursor control 5118 (e.g., mouse or trackball).

According to some embodiments, computer system 5100 performs specific operations by processor 5104 executing one or more sequences of one or more instructions stored in system memory 5106. Such instructions may be read into system memory 5106 from another computer readable medium, such as static storage device 5108 or disk drive 5110. In some embodiments, hard wired circuitry may be used in place of or in combination with software instructions to implement the system.

The term “computer-readable medium” refers to any medium that participates in providing instructions to processor 5104 for execution. Such a medium may take many forms, including but not limited to, nonvolatile media, volatile media, and transmission media. Nonvolatile media includes, for example, optical or magnetic disks, such as disk drive 5110. Volatile media includes dynamic memory, such as system memory 5106. Transmission media includes coaxial cables, copper wire, and fiber optics, including wires that comprise bus 5102. Transmission media may also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer may read.

In some embodiments, execution of the sequences of instructions to practice the system is performed by a single computer system 5100. According to some embodiments, two or more computer systems 5100 coupled by communication link 5120 (e.g., LAN, PSTN, or wireless network) may perform the sequence of instructions to practice the system in coordination with one another. Computer system 5100 may transmit and receive messages, data, and instructions, including program, i.e., application code, through communication link 5120 and communication interface 5112. Received program code may be executed by processor 5104 as it is received, or stored in disk drive 5110 or other nonvolatile storage for later execution, or both.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A system for providing a digital content on a mobile device comprising;
a view for authenticating to the system;
a view for inputting a request for digital content; and
a view for presenting a digital content.

2. The system recited in claim 1, further comprising a view for presenting a plurality of digital content.

3. The system recited in claim 1, further comprising a view for presenting transient digital content.

4. The system recited in claim 1, further comprising a view for presenting help information.

5. The system recited in claim 1, wherein a view includes one or more components such as;
a) a user interface element for initiating a command or activating a functionality of the system;
b) a user interface element for presenting system status;
c) a user interface element for presenting the progress of operations of extended duration;
d) a user interface element for indicating the portion of a digital content presented on the user interface;
e) a user interface element for indicating the availability of additional portions of a digital content presented on the user interface;
f) a user interface element to represent the available set of views;
g) a user interface element to represent the active view;
h) a user interface element for inputting textual information;
i) a user interface element for controlling the presentation of media types such as audio or video;
j) a user interface element for presenting information on status of the system and other user interface elements;
k) a user interface element for presenting information derived from digital content;
l) an auxiliary user interface element presented adjacent to other user interface widgets;
m) an auxiliary user interface element presented overlapping on other user interface widgets;
n) a user interface element presented adjacent to other user interface widgets for inputting textual information;
o) a user interface element presented overlapping on other user interface widgets for inputting textual information;
p) a user interface element for communicating a digital content to a recipient;
q) a user interface element for storing a digital content; or
r) a representation of lighter colored text and graphical elements against a darker colored background.

6. The system recited in claim 1, wherein
a) the views are integrated into the system;
b) the views are integrated into components external to the system.

7. The system recited in claim 1, wherein
a) the views are implemented as tabbed panels;
b) the views are implemented as windows.

8. The system recited in claim 1, wherein the view used for authentication is a login view, the login view including one or more of:
a) a user interface element to input a user identifier;
b) a user interface element to input a password;
c) a user interface element to input speech;
d) a user interface element to input a biometric identifier; or
e) a user interface element to initiate the authentication process.

9. The system recited in claim 1, wherein the view used for inputting textual input is an input view, the input view including one or more of:
a) a user interface element to enter the textual input;
b) presenting text completion options on the user interface element used for entering the textual input;
c) a representation wherein few user interface elements other than the text box are presented; or
d) a representation where the view is superimposed on top of other views.

10. The system recited in claim 1, wherein the view used for presenting help information is a help view, the help view including one or more of:
a) a user interface element for presenting help information;
b) a representation wherein few user interface elements other than the help information are presented; or
c) a representation wherein only the help information is presented.

11. The system recited in claim 1, wherein the view used for presenting and interacting with one or more digital content is an index view, the index view including one or more of:
a) a user interface element for presenting one or more digital content;
b) a user interface element that includes a textual representation of digital content;
c) a user interface element that includes a graphical representation of digital content;
d) a user interface element that includes an audio representation of digital content;
e) a user interface element that includes a video representation of digital content;
f) a user interface element that aids in the selection of one or more digital content;
g) a user interface element that aids in the control of the presentation of audio or video information;
h) a user interface element that indicates whether a digital content has been presented previously;
i) a representation wherein all the digital content presented share a common attribute;
j) a representation wherein few user interface elements other than the digital content are presented;
k) a representation wherein only the digital content is presented;
l) a representation wherein the digital content is presented in a compact form; and
m) a user interface element for initiating presentation of digital content in other components external to the system.

12. The system recited in claim 1, wherein the view used for presenting and interacting with a digital content is a content view, the content view including one or more of
a) a user interface element for presenting a digital content;
b) a user interface element for depicting regions of significance in a digital content;
c) a user interface element for marking regions of significance in a digital content;
d) a user interface element for requesting digital content relevant to regions of significance marked in a digital content;
e) a user interface element for presenting hyperlinks in the digital content;
f) a user interface element for activating hyperlinks in the digital content;
g) a user interface element for initiating presentation of digital content in other components external to the system;
h) a representation wherein few user interface elements other than the digital content are presented; or
i) a representation wherein only the digital content is presented.

13. The system recited in claim 1, wherein the view used for presenting transient digital content is a transient content view, the transient content view including one or more of:
a) a user interface element for presenting the transient digital content.
b) a user interface element for marking regions of significance in the transient digital content.
c) a user interface element for requesting digital content relevant to regions of significance marked in the transient digital content.
d) a user interface element for presenting hyperlinks in the transient digital content.
e) a user interface element for activating hyperlinks in the transient digital content.
f) a user interface element for initiating presentation of digital content in other components external to the system.
g) a representation wherein few user interface elements other than the transient digital content are presented.
h) a representation wherein only the transient digital content is presented.
i) a user interface element to control or skip the presentation of transient digital content.
j) a user interface element to communicate transient digital content.
k) a user interface element to store transient digital content.

14. A method for providing digital content relevant to a query on a mobile device, comprising:
a) presentation of a first view for entering the textual input;
b) presentation of a second view for presenting and interacting with one or more digital content; and
c) presentation of a third view for presenting and interacting with a digital content.

15. The method recited in claim 14, further comprising one or more of:
a) requesting digital content relevant to the entered textual information;
b) presenting the relevant digital content;
c) presenting the relevant digital content in a compact form;
d) selecting one or more digital content for further presentation;
e) selecting one or more digital content for presentation in their entirety;
f) presenting digital content in their entirety;
g) interacting with digital content;
h) launching other components using a hyperlink;
i) marking regions of significance in digital content;
j) requesting digital content relevant to regions of significance in a digital content;
k) requesting digital content similar to one or more selected digital content;
l) communicating a digital content;
m) storing a digital content;
n) presenting transient digital content.
o) presentation of system status; or
p) updating of user interface elements.

16. The method recited in claim 14, further comprising one or more of:
a) authentication of user to system;
b) use of a textual user identifier;
c) use of a graphical user identifier;
d) use of a biometric user identifier;
e) use of a password;
f) initiation of the authentication process by the user; or
g) initiation of the authentication process by the system;

17. A system for providing digital content on a mobile device comprising:
a) a mobile device;
b) a communication network; and
c) a system server.
